(19) United States
(12) Patent Application Publication
(10) Pub. No.: US 2004/0210455 A1
(43) Pub. Date: Oct. 21, 2004

(54) Method and apparatus for promoting individuals and companies and marketing the goods and services of others

(76) Inventor: Sandy Kosloff, Scottsdale, AZ (US)

Correspondence Address: SNELL & WILMER, ONE ARIZONA CENTER, 400 EAST VAN BUREN, PHOENIX, AZ, 850040001

(21) Appl. No.: 10/794,206

(22) Filed: Mar. 5, 2004

Related U.S. Application Data
(60) Provisional application No. 60/452,294, filed on Mar. 5, 2003.

(51) Int. Cl. G06F 17/60; H04K 1/00; H04L 9/00

(52) U.S. Cl. 705/1

(57) ABSTRACT

An electronic information card and method for providing an electronic information card wherein the electronic information card includes more than one piece or set of information and at least two tab members wherein the pieces or sets of information are accessed by clicking on the tab members.

### CROSS REFERENCE TO RELATED APPLICATION

This application claims the benefit of, and priority to, provisional application serial No. 60/452,294, filed Mar. 5, 2003, which application is hereby incorporated by reference in its entirety.

### FIELD OF INVENTION

The present invention is directed to a method and apparatus for promoting individuals and companies and marketing the goods and services of others, and more particularly is directed to an electronic information card and method for accessing an electronic information card wherein the electronic information card includes more than one piece or set of information and at least two tab members wherein the pieces or sets of information are accessed by clicking on the tab members.

### SUMMARY OF THE INVENTION

The present invention is directed to an electronic information card having a first set of information, a second set of information, and at least two tab members where the first and second sets of information are accessed by clicking on the tab members. The present invention is also directed to a method for accessing the electronic information card which includes the steps of providing a first set of information, providing a second set of information, and converting the first and second sets of information into an electronic information card having at least two tab members where the electronic information card is accessible over the internet and the first and second sets of information are obtained by clicking on the tab members.

In one aspect of the invention, the electronic information card may comprise an electronic business card or electronic mailer which includes standard business card information and a photograph of a person or a product, both of which are accessed by clicking on tab members located at the top, side, or bottom of the card for obtaining the business card information or photograph.

In another embodiment of the electronic business card or electronic mailer of the present invention, a biography and/or e-mail address may also be provided and accessed by clicking on separate tab members.

In another aspect of the invention, the electronic information card may comprise an electronic medical information card which includes medical information such as insurance, primary doctor or physicians, prescription information, cardiology information, x-ray information, a medical power of attorney, and other medical related information which a patient or participant may choose to allow others to have access to through the internet.

The present invention is also directed to a method for marketing goods and services for individuals or entities not having a website which includes the steps of providing a universal resource locator for the internet where an individual name, company name or product can be entered, including the universal resource locator advertising for an individual, entity or product, and providing web pages explaining and/or advertising the individual, company or product using the URL.

### BRIEF DESCRIPTION OF THE DRAWINGS

FIGS. 1-4 show examples of the electronic information cards of the present invention and how the method for providing the electronic information cards works.

FIGS. 5-6 show exemplary ads using the method for marketing goods and services for individuals or entities not having a website.

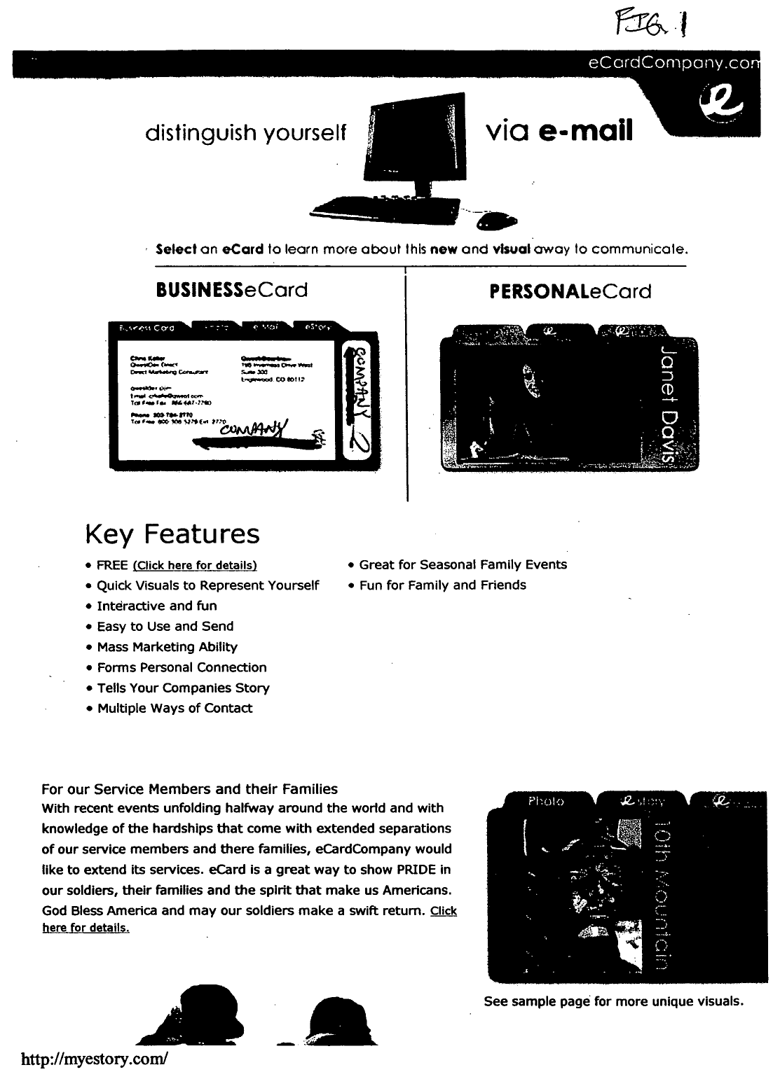

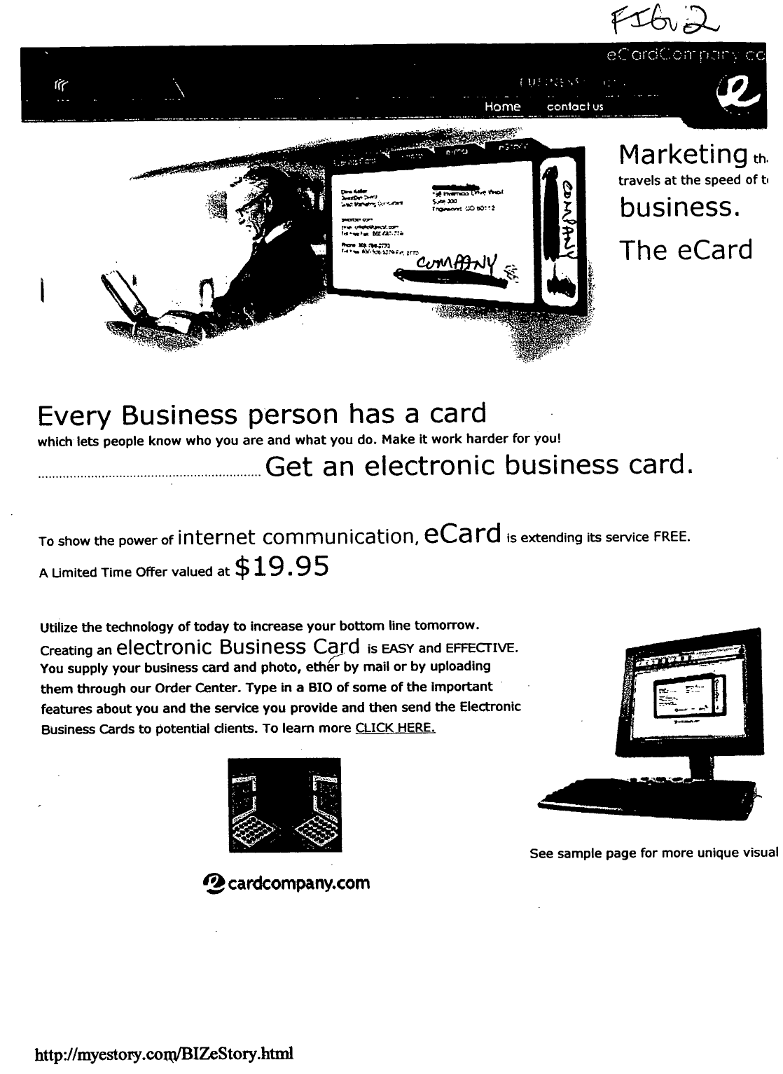

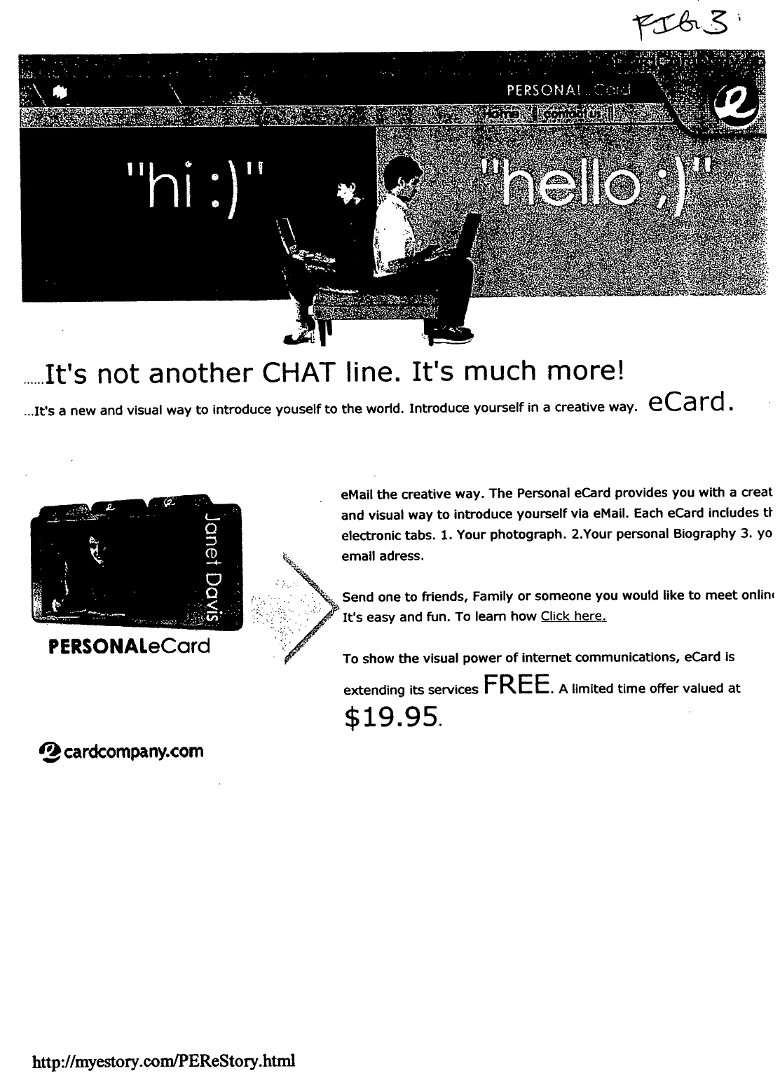

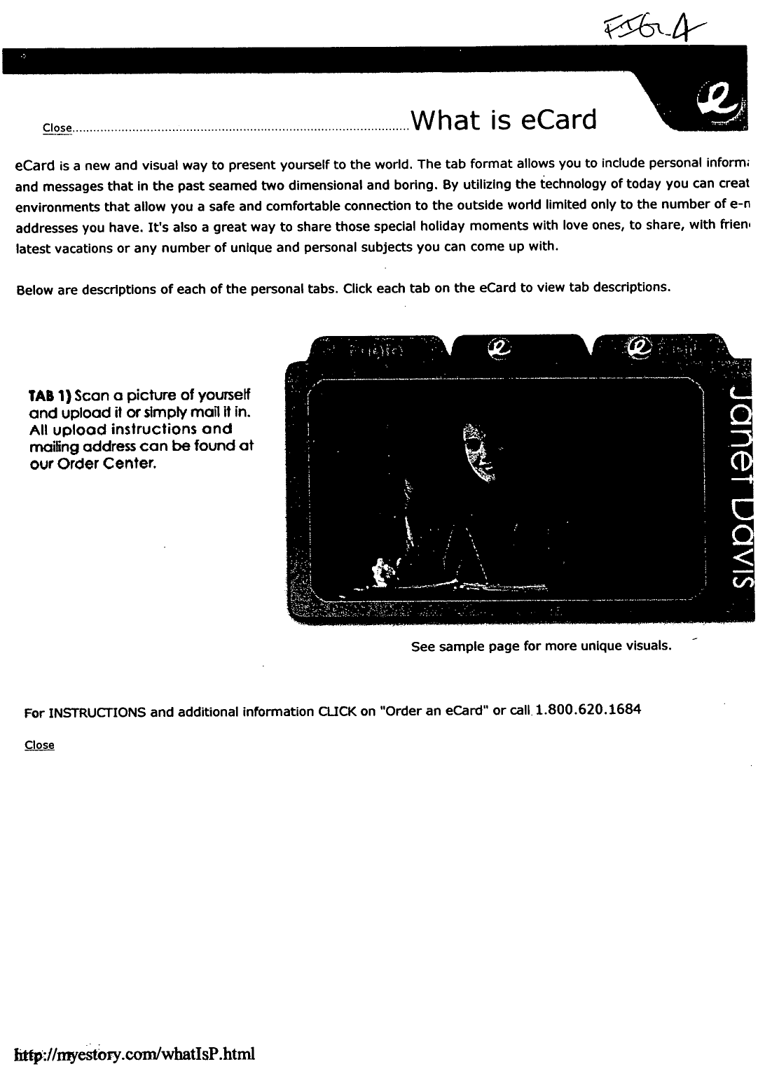

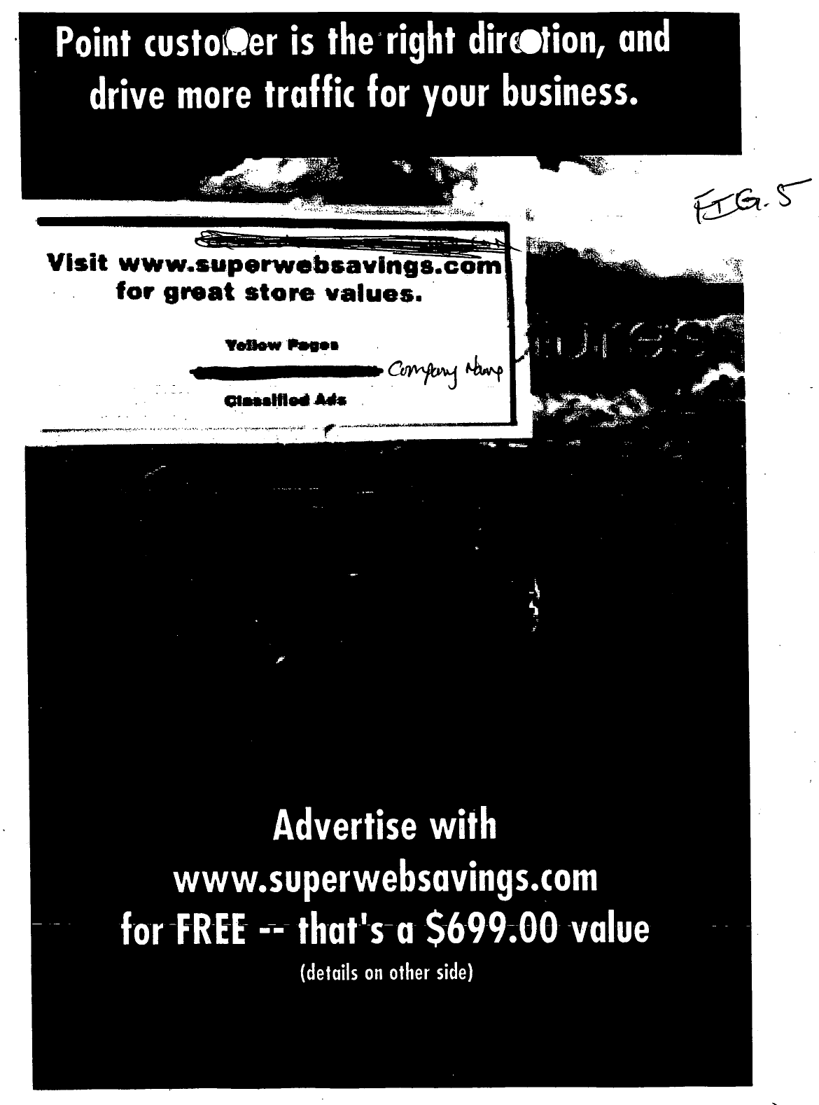

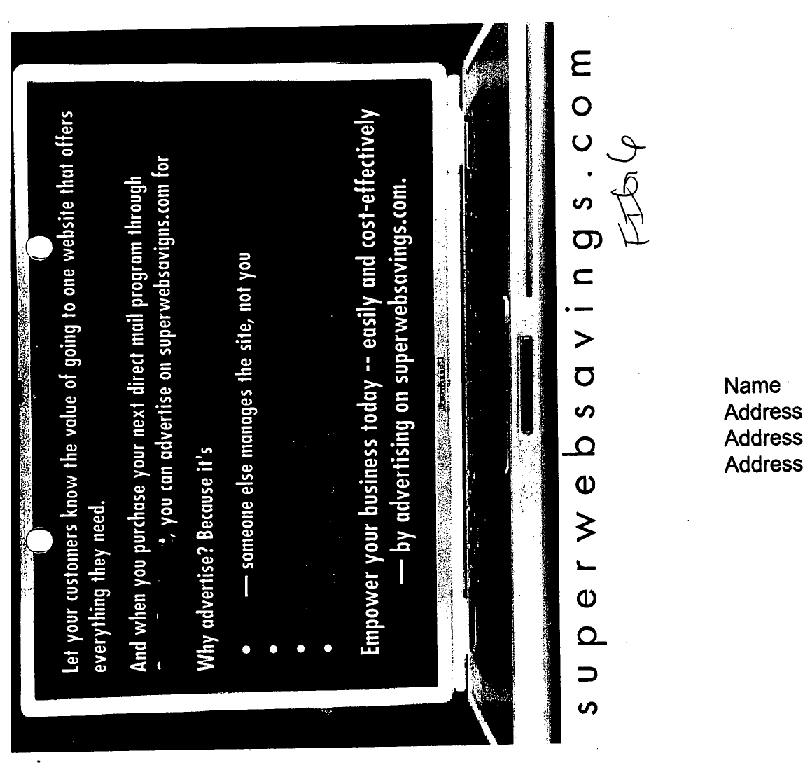

### DETAILED DESCRIPTION

The present invention is directed to a method of doing business through the internet which includes the creation of electronic information or business cards and/or electronic mailers that are created based upon input by an individual or business. The electronic business cards and/or mailers are made available to customers, clients, and/or interested parties of the individual or business by accessing a website.

The present invention is also directed to a method for marketing the goods and services of companies who may not have a website. A URL is provided in advertising for the company (such as on billboards, and yellow pages ads, etc.) and upon entering the URL on the internet, potential customers are asked to identify the company or product they are interested in. Once identified, one or more web pages explaining and advertising the product, company, and/or special offer are detailed.

One example of this method is a web saving program which is a value added marketing program that allows a company to better service the marketing needs for their clients, substantially increase their direct mail revenues, and build name recognition. The web savings program is a user-friendly internet based marketing tool that allows a company to more accurately measure customer response to direct mail and advertising campaigns.

Consumers are provided the opportunity to save money on purchases if they utilize the company web savings program that is tied into a retailer's direct mail or advertising campaign. Ads direct consumers to a URL such as, for example, websavings.com to learn more about specific product promotions, information, discounts and availability. Inquiry information and measured responses from consumers are then utilized by the company to develop more focus direct mail and advertising for their retail/business clients.

Benefits to the company include an increased revenue stream through value added service, differentiation from competitors, and a higher level of customer service. Ben efits to the retailers include more effective and efficient use of advertising dollars, more targeted ad/promotion campaigns, increased service to customers, increased information on consumer preferences, ability to make more informed purchasing decisions, and ability to drive more traffic to their website.

The benefits to customers include product discounts and money savings, convenience and increased service, increased product availability, ease in researching and locating product information, and time savings. The company may also be provided with program implementation and management, website hosting, a customer care center, consumer response feedback and market research, additional promotional opportunities, increased visibility and branding, and increased revenue.

1. A method for creating an electronic business card or electronic mailer comprising the steps of:
providing a business card having business card information;
providing a photograph of at least one of a person and product; and
converting the business card information and photograph into an electronic business card having at least two tab members wherein the electronic business card is accessible over the internet and the business card information and photograph are obtained by clicking on the tab members.

2. The method of claim 1 further comprising the step of providing a biography of at least one of a person, company and product wherein the biography is accessed by clicking on a tab member.

3. The method of claim 1 further comprising the step of providing an e-mail address wherein the e-mail address is accessed by clicking on a tab member.

4. An electronic business card capable of being accessed over the internet comprising:
business card information;
a photograph of at least one of a person and a product; and
at least two tab members wherein the business card information and photograph are accessed by clicking on the tab members.

5. The electronic business card of claim 4 further comprising a biography wherein the biography is accessed by clicking on a tab member.

6. The electronic business card of claim 4 further comprising an e-mail address wherein the e-mail address is accessed by clicking on a tab member.

7. A method for marketing goods and services for individuals or entities not having a website comprising the steps of:
providing a universal resource locator for the internet where an individual name, company name or product can be entered;
including the universal resource locator in advertising for an individual, entity or product; and
providing web pages explaining and/or advertising the individual, company or product.

8. A method for accessing an electronic information card comprising the steps of:
providing a first set of information;
providing a second set of information;
converting the first and second sets of information into an electronic information card having at least two tab members wherein the electronic information card is accessible over the internet and the first and second sets of information are obtained by clicking on the tab members.

9. The method of claim 8 wherein the electronic information card is an electronic medical information card and the first and second sets of information comprise medical information.

10. An electronic information card capable of being accessed over the internet comprising:
a first set of information;
a second set of information; and
at least two tab members wherein the first and second sets of information are accessed by clicking on the tab members.

11. The electronic information card of claim 10 wherein said card is an electronic medical information card and the first and second sets of information comprise medical information.
